(19) United States
(12) Patent Application Publication
(10) Pub. No.: US 2023/0291007 A1
(43) Pub. Date: Sep. 14, 2023

(54) SOLID ELECTROLYTE CERAMIC AND SOLID-STATE BATTERY

(71) Applicant: Murata Manufacturing Co., Ltd., Nagaokakyo-shi (JP)

(72) Inventors: Yusuke TAKARA, Nagaokakyo-shi (JP); Ryohei TAKANO, Nagaokakyo-shi (JP)

(21) Appl. No.: 18/318,136

(22) Filed: May 16, 2023

Related U.S. Application Data
(63) Continuation of application No. PCT/JP2021/042277, filed on Nov. 17, 2021.

(30) Foreign Application Priority Data
Nov. 17, 2020 (JP) 2020-191141

(51) Int. Cl. H01M 10/0562

(52) U.S. Cl. CPC H01M 10/0562; H01M 2300/0071

(57) ABSTRACT

A solid electrolyte ceramic having a garnet-type crystal structure, the solid electrolyte ceramic containing at least Li, La, and O; and one or more transition metal elements selected from the group consisting of Co, Ni, Mn, and Fe, in which a content X (mol %) of one or more elements D selected from the group consisting of a transition element capable of providing six-coordination with oxygen and an element belonging to Groups 12 to 15 and a total content Y (mol %) of the transition metal elements satisfy at least one of three specific relational expressions.

### CROSS REFERENCE TO RELATED APPLICATIONS

The present application is a continuation of International application No. PCT/JP2021/042277, filed Nov. 17, 2021, which claims priority to Japanese Patent Application No. 2020-191141, filed Nov. 17, 2020, the entire contents of each of which are incorporated herein by reference.

### FIELD OF THE INVENTION

The present invention relates to a solid electrolyte ceramic and a solid-state battery containing the solid electrolyte ceramic.

### BACKGROUND OF THE INVENTION

In recent years, the demand for batteries has been greatly expanded as power supplies for portable electronic devices such as mobile phones and portable personal computers. As battery used for such an application, development of a sintered-type solid-state secondary battery (so-called “solid-state battery”) in which a solid electrolyte is used as an electrolyte and other constituent elements are also composed of a solid has been advanced.

The solid-state battery includes a positive electrode layer, a negative electrode layer, and a solid electrolyte layer stacked between the positive electrode layer and the negative electrode layer. In particular, the solid electrolyte layer contains a solid electrolyte ceramic, and is responsible for conduction of ions between the positive electrode layer and the negative electrode layer. The solid electrolyte ceramic is required to have higher ionic conductivity and lower electron conductivity. As such a solid electrolyte ceramic, attempts have been made to use a ceramic obtained by sintering a garnet-type solid electrolyte substituted with Bi from the viewpoint of higher ionic conductivity (for example, Patent Document 1 and Non-Patent Document 1).
Patent Document 1: Japanese Patent Application Laid-Open No. 2015-050071
Non-Patent Document 1: Gao et al., SolidState Ionics, 181 (2010) 1415-1419

### SUMMARY OF THE INVENTION

The inventors of the present invention have found that the following problems occur in a solid-state battery using the conventional solid electrolyte ceramic as described above. Specifically, in a conventional solid-state battery using a garnet-type solid electrolyte ceramic containing Bi, impurities such as a Li—Bi—O-based compound are likely to be generated at a grain boundary, and this Li—Bi—O-based compound is reduced during operation of the solid-state battery (that is, during charging and discharging), and the electron conductivity is increased. When the electron conductivity is increased, a phenomenon that the solid-state battery is short-circuited may occur and/or a leakage current may increase.

The inventors of the present invention have also found that it is effective to contain a transition metal element such as Co from the viewpoint of suppressing the generation of a Li—Bi—O-based compound, and have also found that the following new problems occur. Specifically, when a relatively large amount of a transition metal element such as Co (a first transition metal element described below) is contained, impurities containing a transition metal such as a Li—La—Co—O-based compound different from a Li—Bi—O-based compound are generated, and the impurities also increase the electron conductivity during operation of the solid-state battery.

An object of the present invention is to provide a solid electrolyte ceramic that more sufficiently suppresses an increase in electron conductivity due to operation of a solid-state battery while having excellent ion conductivity.

An object of the present invention is to provide a solid electrolyte ceramic that more sufficiently suppresses an increase in electron conductivity due to operation of a solid-state battery while having excellent ion conductivity when a relatively large amount of a transition metal element (a first transition metal element described below) is contained.

The present invention relates to a solid electrolyte ceramic having a garnet-type crystal structure, the solid electrolyte ceramic containing at least lithium (Li), lanthanum (La), and oxygen (O); and one or more transition metal elements selected from the group consisting of cobalt (Co), nickel (Ni), manganese (Mn), and iron (Fe), the solid electrolyte ceramic having a chemical composition represented by:

A_{α}B_{β}D_{γ}O_{ω} (I)
wherein A is one or more elements selected from the group consisting of the lithium (Li), gallium (Ga), aluminum (Al), magnesium (Mg), zinc (Zn), and scandium (Sc), and includes at least the lithium (Li);
B is one or more elements selected from the group consisting of the lanthanum (La), calcium (Ca), strontium (Sr), barium (Ba), and lanthanoid elements, and includes at least the lanthanum (La);
D is one or more elements selected from the group consisting of a transition element capable of providing six-coordination with oxygen and an element belonging to Groups 12 to 15;
5.0≤α≤8.0;
2.5≤β≤3.5;
1.5≤γ≤2.5; and
11≤ω≤13,
wherein, when a content of the B is 100 mol %, a content of the D is designated as X (mol %), and a total content of the transition metal elements is designated as Y (mol %), the solid electrolyte ceramic satisfies any one of relational expressions (1) to (3):

0.01≤Y≤4.00 in a range of 12.0≤X<20.0; (1)

0.01≤Y≤6.00 in a range of 20.0≤X<33.0; (2)

0.01≤Y≤8.00 in a range of 33.0≤X≤65.5. (3)

The solid electrolyte ceramic of the present invention more sufficiently suppresses an increase in electron conductivity due to operation of a solid-state battery while having excellent ion conductivity.

### DETAILED DESCRIPTION OF THE INVENTION

[Solid Electrolyte Ceramic]

A solid electrolyte ceramic of the present invention includes a sintered body formed by sintering solid electrolyte particles. The solid electrolyte ceramic of the present invention is a solid electrolyte ceramic containing at least lithium (Li), lanthanum (La), and oxygen (O) and having a garnet-type crystal structure, and further contains one or more transition metal elements (hereinafter, simply referred to as “first transition metal element” in some cases) selected from the group consisting of cobalt (Co), nickel (Ni), manganese (Mn), and iron (Fe). The solid electrolyte ceramic of the present invention is a ceramic having a garnet-type crystal structure, and may contain other composite oxides or single oxides as long as the effect of the present invention is not impaired. The solid electrolyte ceramic preferably contains bismuth (Bi) from the viewpoint of more excellent ion conductivity and more sufficient suppression of an increase in electron conductivity during operation. At least sintered grains contained in the solid electrolyte ceramic as a main component of the present invention may have a garnet-type crystal structure.

The solid electrolyte ceramic of the present invention preferably further contains the first transition metal element while having the chemical composition represented by Formula (I):

A_{α}B_{β}D_{γ}O_{ω} (I)

In Formula (I), A is one or more elements selected from the group consisting of lithium (Li), gallium (Ga), aluminum (Al), magnesium (Mg), zinc (Zn), and scandium (Sc), and includes at least lithium (Li).

B is one or more elements selected from the group consisting of lanthanum (La), calcium (Ca), strontium (Sr), barium (Ba), and lanthanoid elements, and includes at least lanthanum (La). Examples of the lanthanoid elements include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

D is one or more elements selected from the group consisting of a transition element capable of providing six-coordination with oxygen and a typical element belonging to Groups 12 to 15. Examples of the transition element capable of providing six-coordination with oxygen include scandium (Sc), zirconium (Zr), titanium (Ti), tantalum (Ta), niobium (Nb), hafnium (Hf), molybdenum (Mo), tungsten (W), and tellurium (Te)). Examples of the typical element belonging to Groups 12 to 15 include indium (In), germanium (Ge), tin (Sn), lead (Pb), antimony (Sb), and bismuth (Bi). D preferably includes at least Bi and/or Ta, more preferably Bi and Ta, and still more preferably Bi, Ta, and Zr, from the viewpoint of more excellent ion conductivity and more sufficient suppression of an increase in electron conductivity during operation.

In Formula (I), α, β, γ, and ω satisfy 5.0≤α≤8.0, 2.5≤β≤3.5, 1.5≤γ≤2.5, and 11≤ω≤13, respectively.

α preferably satisfies 5.0≤α≤7.0, more preferably 5.00≤α≤6.35, still more preferably 5.80≤α≤6.35, and particularly preferably 6.15≤α≤6.35, from the viewpoint of more excellent ion conductivity and more sufficient suppression of an increase in electron conductivity during operation.

β preferably satisfies 2.5≤β≤3.3, more preferably 2.5≤β≤3.1, and still more preferably 2.8≤B≤3.0, from the viewpoint of more excellent ion conductivity and more sufficient suppression of an increase in electron conductivity during operation.

γ preferably satisfies 1.8≤γ≤2.5, more preferably 1.8≤γ≤2.3, and still more preferably 1.9≤γ≤2.3, from the viewpoint of more excellent ion conductivity and more sufficient suppression of an increase in electron conductivity during operation.

ω preferably satisfies 11≤ω≤12.5 and more preferably 11.5≤ω≤12.5, from the viewpoint of more excellent ion conductivity and more sufficient suppression of an increase in electron conductivity during operation.

In the present invention, when the solid electrolyte ceramic has the chemical composition represented by Formula (I) and satisfies any one relational expression of the relational expressions (1) to (3) described above when a content of the B is 100 mol %, a content of the D is designated as X (mol %), and a total content of the first transition metal elements is designated as Y (mol %), an increase in electron conductivity is sufficiently suppressed while excellent ion conductivity is attained when a relatively large amount of the first transition metal element is contained. In such a solid electrolyte ceramic, when the total content of the D is too small, an increase in electron conductivity cannot be sufficiently suppressed. When the total content of the D is too large, the ion conductivity is deteriorated. In the present invention, it is preferable that D further includes one or more transition metal elements selected from the group consisting of tantalum (Ta) and niobium (Nb) (hereinafter, simply referred to as “second transition metal element” in some cases).

In the present invention, the contents of the D and the first transition metal element in the solid electrolyte ceramic are specifically as follows. That is, when a content of B in Formula (I) representing the chemical composition of the solid electrolyte ceramic of the present invention is 100 mol %, a total content of the D is X (mol %), and a total content of the first transition metal elements is Y (mol %), the solid electrolyte ceramic of the present invention satisfies any one relational expression of relational expressions (1) to (3) shown below:
(1) 0.01≤Y≤4.00 (composite range of 0.01≤Y<1.40 and 1.40≤Y≤4.00) in the range of 12.0≤X<20.0 (particularly, 13.0≤X<20.0 or 13.0≤X≤18.0) (from the viewpoint of more excellent ion conductivity and more sufficient suppression of an increase in electron conductivity during operation, preferably 0.01≤Y≤3.50 (composite range of 0.01≤Y<1.50 and 1.50≤Y≤3.50), more preferably 0.02≤Y≤3.40 (composite range of 0.02≤Y<1.60 and 1.60≤Y≤3.40));
(2) 0.01≤Y≤6.00 (composite range of 0.01≤Y<1.40 and 1.40≤Y≤6.00) in the range of 20.0≤X<33.0 (particularly 20.0≤X≤30) (from the viewpoint of more excellent ion conductivity and more sufficient suppression of an increase in electron conductivity during operation, preferably 0.01≤Y≤5.50 (composite range of 0.01≤Y<1.50 and 1.50≤Y≤5.50), more preferably 0.02≤Y≤5.20 (composite range of 0.02≤Y<1.60 and 1.60≤Y≤5.20)); and
(3) 0.01≤Y≤8.00 (composite range of 0.01≤Y<1.40 and 1.40≤Y≤8.00) in the range of 33.0≤X≤65.5 (particularly 33.0≤X≤65.0) (from the viewpoint of more excellent ion conductivity and more sufficient suppression of an increase in electron conductivity during operation, preferably 0.01≤Y≤7.50 (composite range of 0.01≤Y<1.50 and 1.50≤Y≤7.50), more preferably 0.02≤Y≤7.00 (composite range of 0.02≤Y<1.60 and 1.60≤Y≤7.00)). D preferably includes the second transition metal element of the present invention and the content of the second transition metal element more preferably satisfies the range of X.

In each of the relational expressions (1) to (3), when the total content Y of the first transition metal elements is excessively larger than a predetermined value, an increase in electron conductivity cannot be sufficiently suppressed.

The total content X of D defined in the present invention is preferably the total content Ta and/or Nb and Bi, more preferably the total content of Ta and/or Nb and Bi and Zr, still more preferably the contents of Ta and Bi, and particularly preferably the content of Ta, from the viewpoint of more excellent ion conductivity and more sufficient suppression of an increase in electron conductivity during operation.

The total content X of the D and the total content Y of the first transition metal elements described above are expressed as a ratio (mol %) when the content of the B is 100 mol %, but can also be expressed as a ratio (mol %) when the number of eight-coordination sites in the garnet-type crystal structure is 100 mol %. For example, in the case of the chemical composition of Formula (II) described below, the ratio is a value that can be expressed as a ratio (mol %) when the total number of La and B¹ is 100 mol %. In another specific example, the eight-coordination site in the garnet-type crystal structure is, for example, a site occupied by La in Li₅La₃Nb₂O₁₂ (ICDD Card No. 00-045-0109) having a garnet-type crystal structure, and a site occupied by La in Li₇La₃Zr₂O₂ (ICDD Card. No 01-078-6708) having a garnet-type crystal structure.

The content of D and the content of the first transition metal element can also be measured by performing inductively coupled plasma (ICP) emission spectrometry (ICP analysis) of the solid electrolyte ceramic to obtain the average chemical composition of the material. Specifically, the average chemical composition is determined based on ICP analysis, and from the average chemical composition, the contents of the elements included in D, for example, the contents of Ta and Nb and the contents of Co, Mn, Ni, and Fe can be determined as a ratio when the content of B in Formula (I) described above (for example, the total number of La and B¹ in Formula (II) described below) is 100 mol %. Measurement and calculation may be performed by an X-ray photoelectron spectroscopy analyzer (XPS: X-ray Photoelectron Spectroscopy).

When the content of D is 100 mol %, the content of bismuth (Bi) is usually 25 mol % or less, and is preferably more than 0 mol % and 25 mol % or less, more preferably more than 0 mol % and 15 mol % or less, still more preferably more than 0 mol % and 12 mol % or less, particularly preferably 1 mol % to 12 mol %, and most preferably 5 mol % to 12 mol, from the viewpoint of more excellent ion conductivity and more sufficient suppression of an increase in electron conductivity during operation.

Similarly to the content of the first transition metal element, the content of Bi can also be measured by performing inductively coupled plasma (ICP) emission spectrometry (ICP analysis) of the solid electrolyte ceramic to obtain the average chemical composition of the material. Specifically, the average chemical composition is determined based on ICP analysis, and from the average chemical composition, the content of Bi can be determined as a ratio when the content of D in Formula (I) described above (for example, the total number of Bi and D¹ in Formula (II) described below) is 100 mol %. Measurement and calculation may be performed by an X-ray photoelectron spectroscopy analyzer (XPS: X-ray Photoelectron Spectroscopy).

The solid electrolyte ceramic of the present invention preferably satisfies the relational expression (1) or (2) described above and more preferably the relational expression (1) described above, from the viewpoint of more excellent ion conductivity and more sufficient suppression of an increase in electron conductivity during operation.

The existence form (or contained form) of the first transition metal element in the solid electrolyte ceramic of the present invention is not particularly limited, and the predetermined transition metal element may exist in a crystal lattice or may exist other than the crystal lattice. For example, the first transition metal element may be present in the bulk, at the grain boundary, or in both of them in the solid electrolyte ceramic. As an example in which the first transition metal element is present in the bulk, it means that in the solid electrolyte ceramic of the present invention, the first transition metal element is present at a metal site (lattice site) constituting a garnet-type crystal structure. The metal site may be any metal site, and may be, for example, a Li site, a La site, a Bi site, or two or more kinds of these sites. The solid electrolyte ceramic of the present invention includes a plurality of sintered grains, and the first transition metal element may be present at an interface between two or more sintered grains.

When the solid electrolyte ceramic of the present invention contains Bi, the existence form (or contained form) of bismuth (Bi) in the solid electrolyte ceramic of the present invention is not particularly, and for example, the bismuth (Bi) may be present in the bulk, at the grain boundary, or in both of them in the solid electrolyte ceramic. From the viewpoint of insulating properties, Bi is preferably present in the bulk. As an example in which Bi is present in the bulk, in the solid electrolyte ceramic of the present invention, the Bi may be present at a metal site (lattice site) constituting a garnet-type crystal structure.

In the present invention, the first transition metal and/or bismuth (Bi) may be contained in a ceramic having a garnet-type crystal structure. The first transition metal and/or bismuth (Bi) may exist as a composite oxide and/or a single oxide containing the first transition metal and/or bismuth (Bi) and/or the element constituting the garnet-type solid electrolyte of the present invention. The oxide may be present at the interface between crystal grains of the ceramic having a garnet-type crystal structure as a main component of the present invention.

Each of lithium (Li) and lanthanum (La) in the solid electrolyte ceramic of the present invention may be usually present in the bulk, and specifically, as an example, in the solid electrolyte ceramic of the present invention, each of lithium (Li) and lanthanum (La) may be present at a Li site and a La site as metal sites (lattice sites) constituting a garnet-type crystal structure. At this time, some of lithium (Li) and lanthanum (La) may be present at a grain boundary as independent or composite oxides.

The first transition metal element contained in the solid electrolyte ceramic of the present invention is preferably selected from the group consisting of Co, Ni, and Mn, more preferably selected from the group consisting of Co and Mn, and still more preferably includes Co, from the viewpoint of more sufficient suppression of an increase in electron conductivity during operation.

The element and the second transition metal element included in D in the solid electrolyte ceramic of the present invention are present in the bulk, specifically, present at metal sites (particularly, six-coordination sites) constituting the garnet-type crystal structure.

The element and the second transition metal element included in D contained in the solid electrolyte ceramic of the present invention preferably include Ta from the viewpoint of more excellent ion conductivity and more sufficient suppression of an increase in electron conductivity during operation.

In the present invention, the fact that the solid electrolyte ceramic has a garnet-type crystal structure means that the solid electrolyte ceramic has not only a “garnet-type crystal structure” but also a “pseudo-garnet-type crystal structure”. Specifically, the solid electrolyte ceramic of the present invention has a crystal structure that can be recognized as a garnet-type or pseudo-garnet-type crystal structure by those skilled in the art of solid-state batteries in X-ray diffraction. More specifically, the solid electrolyte ceramic of the present invention may show, in X-ray diffraction, one or more main peaks corresponding to a Miller index unique to a so-called garnet-type crystal structure (diffraction pattern: ICDD Card No. 422259) at a predetermined incident angle, or as a pseudo-garnet-type crystal structure, one or more main peaks corresponding to a Miller index unique to a so-called garnet-type crystal structure may show one or more main peaks having different incident angles (that is, peak positions or diffraction angles) and intensity ratios (that is, peak intensities or diffraction intensity ratios) due to a difference in composition. Examples of a typical diffraction pattern of the pseudo-garnet-type crystal structure include ICDD Card No. 00-045-0109.

As a specific embodiment, the solid electrolyte ceramic of the present invention can be usually Formula (II). Specifically, the solid electrolyte ceramic has the chemical composition represented by Formula (II). The solid electrolyte ceramic of the present invention at this time further contains the first transition metal element as described above while having the chemical composition represented by Formula (II):

(LiₚA¹_{y})(La_{3-z}B¹_{z})(D¹_{y-x1-x2}Mₓ₁Biₓ₂)O_{12-δ} (II)

In Formula (II), A¹ refers to a metal element occupying the Li site in the garnet-type crystal structure. A¹ is an element corresponding to A in Formula (I) described above, and may be one or more elements selected from the group consisting of elements other than Li among elements similar to the elements exemplified as A. A¹ is usually one or more elements selected from the group consisting of gallium (Ga), aluminum (Al), magnesium (Mg), zinc (Zn), and scandium (Sc). A¹ is preferably one or more elements selected from the group consisting of gallium (Ga) and aluminum (Al), and more preferably two elements of Ga and Al from the viewpoint of more excellent ion conductivity and more sufficient suppression of an increase in electron conductivity during operation.

In Formula (II), B¹ refers to a metal element occupying the La site in the garnet-type crystal structure. B¹ is an element corresponding to B in Formula (I) described above, and may be one or more elements selected from the group consisting of elements other than La among elements similar to the elements exemplified as B. B¹ is usually one or more elements selected from the group consisting of calcium (Ca), strontium (Sr), barium (Ba), and lanthanoid elements.

In Formula (II), D¹ refers to a metal element occupying the six-coordination site in the garnet-type crystal structure (the site occupied by Zr in the garnet-type crystal structure Li₇La₃Zr₂O₁₂ (ICDD Card. No 01-078-6708)). D¹ is an element corresponding to D in Formula (I) described above, and may be one or more elements selected from the group consisting of elements other than Bi and M described below among elements similar to the elements exemplified as D. D¹ is one or more elements selected from the group consisting of zirconium (Zr), hafnium (Hf), molybdenum (Mo), tungsten (W), and tellurium (Te), and preferably includes zirconium (Zr) from the viewpoint of more excellent ion conductivity and more sufficient suppression of an increase in electron conductivity during operation.

M is the second transition metal element described above.

In Formula (II), x1 corresponds to 0.03×X with respect to X described above, usually satisfies 0.36≤x1≤1.965, particularly 0.39≤x1≤1.95, and preferably satisfies a range converted from the range of X in the relational expressions (1) and (2) described above, more preferably a range converted from the range of X in the relational expression (1), from the viewpoint of more excellent ion conductivity and more sufficient suppression of an increase in electron conductivity during operation. The range converted from the range of X in the relational expression is a range of x1 calculated by multiplying the range of X by 0.03, and for example, a range converted from 12.0≤X<20.0 in the relational expression (1) is 0.36≤x1<0.60.

x2 satisfies 0<x2≤1.00, and preferably satisfies 0.01≤x2≤0.70, more preferably 0.02≤x2≤0.40, still more preferably 0.10≤x2≤0.40, particularly preferably 0.20≤x2≤0.35, and most preferably 0.25≤x2≤0.35, from the viewpoint of more excellent ion conductivity and more sufficient suppression of an increase in electron conductivity during operation.

x1+x2 usually satisfies 0.50≤x1+x2≤2.00, and preferably satisfies 0.50≤x1+x2≤1.90, more preferably 0.50≤x1+x2≤1.50, still more preferably 0.50≤x1+x2≤1.20, particularly preferably 0.50≤x1+x2≤1.00, and most preferably 0.60≤x1+x2≤0.85, from the viewpoint of more excellent ion conductivity and more sufficient suppression of an increase in electron conductivity during operation.

y satisfies 0≤y≤0.50, preferably satisfies 0≤y≤0.40, more preferably 0≤y≤0.30, and still more preferably 0≤y≤0.20, and is particularly preferably 0, from the viewpoint of more excellent ion conductivity and more sufficient suppression of an increase in electron conductivity during operation.

z satisfies 0≤z≤2.00, preferably satisfies 0≤z≤1.00 and more preferably 0≤z≤0.50, and is still more preferably 0, from the viewpoint of more excellent ion conductivity and more sufficient suppression of an increase in electron conductivity during operation.

γ satisfies 1.5≤γ≤2.5, and preferably satisfies 1.8≤γ≤2.5, more preferably 1.8≤γ≤2.3, and still more preferably 1.9≤γ≤2.3, from the viewpoint of more excellent ion conductivity and more sufficient suppression of an increase in electron conductivity during operation.

In Formula (II), p usually satisfies 5.00≤p≤6.35, and preferably satisfies 5.80≤p≤6.35 and more preferably 6.15≤p≤6.35, from the viewpoint of more excellent ion conductivity and more sufficient suppression of an increase in electron conductivity during operation.

a is an average valence of A¹. The average valence of A¹ is, for example, a value represented by (n1×a+n2×b+n3×c)/(n1+n2+n3) when A¹ is recognized as n1 of elements X having a valence a+, n2 of elements Y having a valence b+, and n3 of elements Z having a valence c+.

b is an average valence of B¹. The average valence of B¹ is, for example, the same value as the average valence of A¹ described above when B¹ is recognized as n1 of elements X having a valence a+, n2 of elements Y having a valence b+, and n3 of elements Z having a valence c+.

c is an average valence of D¹. The average valence of D¹ is, for example, the same value as the average valence of A¹ described above when D¹ is recognized as n1 of elements X having a valence a+, n2 of elements Y having a valence b+, and n3 of elements Z having a valence c+.

δ represents an oxygen deficiency amount and may be 0. δ may usually satisfy 0≤δ<1. The oxygen deficiency amount 5 is difficult to be quantitatively analyzed with the latest device, and thus may be considered to be 0.

The molar ratio of each element in the chemical composition of the solid electrolyte ceramic of the present invention does not necessarily coincide with, for example, the molar ratio of each element in Formula (II), and tends to deviate more than that depending on the analysis method, but the effect of the present invention is exhibited unless the composition deviation is such that the properties change.

In the present invention, the chemical composition of the solid electrolyte ceramic may be the composition of the whole ceramic material determined using an inductively coupled plasma method (ICP). The chemical composition may be measured and calculated using XPS analysis, or may be determined using energy dispersive X-ray spectroscopy (TEM-EDX) and/or wavelength dispersive X-ray spectroscopy (WDX). The chemical composition may be obtained by performing quantitative analysis (composition analysis) at any 100 points of each of any 100 sintered grains and calculating the average value thereof.

The contents of the first transition metal elements (that is, Co, Ni, Mn, and Fe) in the solid electrolyte ceramic of the present invention [for example, the molar ratio when the content of B in Formula (I) described above (or the total number of La and B¹ in Formula (II) described above) is 100 mol %] may be calculated by the following method. In the present invention, the chemical composition of the solid electrolyte ceramic can be determined by ICP analysis (inductively coupled plasma method), laser ablation ICP mass spectrometry (LA-ICP-MS) analysis, or the like. The chemical composition may be measured and calculated using XPS analysis or using energy dispersive X-ray spectroscopy (TEM-EDX) and/or wavelength dispersive X-ray spectroscopy (WDX). The chemical composition may be obtained by performing quantitative analysis (composition analysis) at any 100 points of each of any 100 sintered grains and calculating the average value thereof.

For example, analysis by EDX or WDX measures a cross-section of a solid-state battery. The cross-section of the solid-state battery is a cross-section parallel to the stacking direction of the positive electrode layer, the solid electrolyte layer, and the negative electrode layer. The cross-section of the solid-state battery can be exposed by embedding the solid-state battery in a resin and then performing polishing. The method of polishing the cross-section is not particularly limited, but the solid electrolyte layer can be exposed by cutting with a dicer or the like and then polishing the cross-section using polishing paper, chemical mechanical polishing, ion milling, or the like. The exposed cross-section (solid electrolyte layer) is quantitatively analyzed by EDX or WDX (wavelength dispersive X-ray fluorescence spectrometer), whereby the molar ratios of Co, Ni, Mn, and Fe to B can be calculated.

For example, in TEM-EELS measurement, an electrode layer or a solid electrolyte layer of the solid-state battery is peeled using a focused ion beam (FIB) or the like, and then transmission microscope-electron energy-loss spectroscopy (TEM-EELS) measurement of the solid electrolyte site is performed. As a result, elements contained in B in Formula (I), and Co, Ni, Mn, and Fe are detected, and the molar ratios of Co, Ni, Mn, and Fe to the content of B can be calculated.

Specific examples of the chemical composition indicating the solid electrolyte ceramic of the present invention include the following chemical compositions. In the chemical composition shown below, the transition metal element after the hyphen (-) may be present in the bulk and/or at the grain boundary as described above.
Li_{6.3}La₃Zr_{1.28}Ta_{0.42}Bi_{0.3}O₁₂—Co_{0.05}
Li_{6.3}La₃Zr_{1.2}Ta_{0.42}Bi_{0.3}O₁₂—Co_{0.1}
Li_{6.2}La₃Zr_{1.2}Ta_{0.5}Bi_{0.3}O₁₂—Co_{0.05}
Li_{6.2}La₃Zr_{1.2}Ta_{0.5}Bi_{0.3}O₁₂—Co_{0.1}
Li_{6.1}La₃Zr_{1.1}Ta_{0.6}Bi_{0.3}O₁₂—Co_{0.05}
Li_{6.1}La₃Zr_{1.1}Ta_{0.6}Bi_{0.3}O₁₂—Co_{0.1}
Li_{6.1}La₃Zr_{1.1}Ta_{0.6}Bi_{0.3}O₁₂—Co_{0.15}
Li_{5.9}La₃Zr_{0.9}Ta_{0.8}Bi_{0.3}O₁₂—Co_{0.05}
Li_{5.9}La₃Zr_{0.9}Ta_{0.8}Bi_{0.3}O₁₂—Co_{0.1}
Li_{5.9}La₃Zr_{0.9}Ta_{0.8}Bi_{0.3}O₁₂—Co_{0.15}
Li_{5.7}La₃Zr_{0.7}Ta₁Bi_{0.3}O₁₂—Co_{0.05}
Li_{5.7}La₃Zr_{0.7}Ta₁Bi_{0.3}O₁₂—Co_{0.1}
Li_{5.7}La₃Zr_{0.7}Ta₁Bi_{0.3}O₁₂—Co_{0.15}
Li_{5.7}La₃Zr_{0.7}Ta₁Bi_{0.3}O₁₂—Co_{0.2}
Li_{5.2}La₃Zr_{0.2}Ta_{1.5}Bi_{0.3}O₁₂—Co_{0.05}
Li_{5.2}La₃Zr_{0.2}Ta_{1.5}Bi_{0.3}O₁₂—Co_{0.1}
Li_{5.2}La₃Zr_{0.2}Ta_{1.5}Bi_{0.3}O₁₂—Co_{0.15}
Li_{5.2}La₃Zr_{0.2}Ta_{1.5}Bi_{0.3}O₁₂—Co_{0.2}
Li₅La₃Ta_{1.95}Bi_{0.05}O₁₂—Co_{0.05}
Li₅La₃Ta_{1.95}Bi_{0.05}O₁₂—Co_{0.1}
Li₅La₃Ta_{1.95}Bi_{0.05}O₁₂—Co_{0.15}
Li₅La₃Ta_{1.95}Bi_{0.05}O₁₂—Co_{0.2}

Specific examples of the chemical composition described above include Co as a transition element, but may include Ni, Mn, or Fe instead of Co.

[Method for Producing Solid Electrolyte Ceramic]

The solid electrolyte ceramic of the present invention can be obtained by mixing a compound containing a predetermined metal element (that is, a starting material) with water, drying the mixture, and then heat-treating the mixture in O₂. The compound containing a predetermined metal element is usually a mixture of compounds containing lithium (Li), lanthanum (La), bismuth (Bi), and one metal element selected from the group consisting of the first transition metal element and the second transition metal element. Examples of the compound containing a predetermined metal element (that is, a starting material) include lithium hydroxide monohydrate LiOH·H₂O, lanthanum hydroxide La(OH)₃, zirconium oxide ZrO₂, tantalum oxide Ta₂O₅, bismuth oxide Bi₂O₃, cobalt oxide CO₃O₄, basic nickel carbonate hydrate NiCO₃·2Ni(OH)₂·4H₂O, manganese carbonate MnCO₃, iron oxide Fe₂O₃, lithium nitrate LiNO₃, lanthanum nitrate hexahydrate La(NO₃)₃·6H₂O, bismuth nitrate pentahydrate Bi(NO₃)₃·5H₂O, and cobalt nitrate. The mixing ratio of the compound containing a predetermined metal element may be such a ratio that the solid electrolyte ceramic of the present invention has a predetermined chemical composition after the heat treatment. The heat treatment temperature is usually 500° C. or higher and 1200° C. or lower, and preferably 600° C. or higher and 1000° C. or lower. The heat treatment time is usually 10 minutes or longer and 1440 minutes or shorter, particularly is 60 minutes or longer and 600 minutes or shorter.

The solid electrolyte ceramic of the present invention may contain a sintering aid. As the sintering aid, various sintering aids known in the field of solid-state batteries can be used. The composition of such a sintering aid contains at least lithium (Li), boron (B), and oxygen (O), and the molar ratio of Li to B (Li/B) is preferably 2.0 or more. Specific examples of such a sintering aid include Li₃BO₃, (Li_{2.7}Al_{0.3}) BO₃, Li_{2.8}(B_{0.8}C_{0.2})O₃, and LiBO₂.

The content of the sintering aid is usually 0% to 10%, particularly preferably 0% to 5% with respect to the volume ratio of the garnet-type solid electrolyte.

[Solid-State Battery]

The “solid-state battery” in the present specification refers to a battery whose constituent elements (especially electrolyte layers) are formed of solids in a broad sense and refers to an “all-solid-state battery” whose constituent elements (especially all constituent elements) are formed of solids in a narrow sense. The “solid-state battery” in the present specification encompasses a so-called “secondary battery” that can be repeatedly charged and discharged and a “primary battery” that can only be discharged. The “solid-state battery” is preferably the “secondary battery”. The “secondary battery” is not excessively limited by its name and can include, for example, an electrochemical device such as a “power storage device”.

The solid-state battery of the present invention includes a positive electrode layer, a negative electrode layer, and a solid electrolyte layer, and usually has a stacked structure in which the positive electrode layer and the negative electrode layer are stacked with the solid electrolyte layer interposed therebetween. Each of the positive electrode layer and the negative electrode layer may be stacked in two or more layers as long as a solid electrolyte layer is provided therebetween. The solid electrolyte layer in contact with the positive electrode layer and the negative electrode layer is sandwiched therebetween. The positive electrode layer and the solid electrolyte layer may have sintered bodies sintered integrally with each other, and/or the negative electrode layer and the solid electrolyte layer may have sintered bodies sintered integrally with each other. Having sintered bodies sintered integrally with each other means that two or more members (in particular, layers) adjacent to or in contact with each other are joined by sintering. Here, the two or more members (in particular, layers) may be integrally sintered while they are sintered bodies.

The solid electrolyte ceramic of the present invention described above is useful as a solid electrolyte of a solid-state battery. Thus, the solid-state battery of the present invention contains the solid electrolyte ceramic of the present invention described above as a solid electrolyte. Specifically, the solid electrolyte ceramic of the present invention is contained as a solid electrolyte in at least one layer selected from the group consisting of a positive electrode layer, a negative electrode layer, and a solid electrolyte layer. The solid electrolyte ceramic of the present invention is preferably contained in at least the solid electrolyte layer from the viewpoint of more excellent ion conductivity in the solid electrolyte layer and more sufficient suppression of an increase in electron conductivity during operation.

(Positive Electrode Layer)

In the solid-state battery of the present invention, the positive electrode layer is not particularly limited. For example, the positive electrode layer contains a positive electrode active material and may further contain the solid electrolyte ceramic of the present invention. When the solid electrolyte ceramic of the present invention is contained in the positive electrode layer, a short circuit of the solid-state battery can be suppressed. The positive electrode layer may have a form of a sintered body containing positive electrode active material particles. The positive electrode layer may be a layer capable of occluding and releasing ions (in particular, lithium ions).

The positive electrode active material is not particularly limited, and a positive electrode active material known in the field of solid-state batteries can be used. Examples of the positive electrode active material include lithium-containing phosphate compound particles that have a NASICON-type structure, lithium-containing phosphate compound particles that have an olivine-type structure, lithium-containing layered oxide particles, lithium-containing oxide particles which have a spinel-type structure. Specific examples of a lithium-containing phosphoric acid compound that has a NASICON-type structure and is to be preferably used include Li₃V₂(PO₄)₃, and the like. Specific examples of the lithium-containing phosphate compound having an olivine-type structure preferably used include Li₃Fe₂(PO₄)₃ and LiMnPO₄. Specific examples of the lithium-containing layered oxide particles preferably used include LiCoO₂, and LiCo_{1/3}Ni_{1/3}Mn_{1/3}O₂. Specific examples of the preferably used lithium-containing oxide having a spinel-type structure include LiMn₂O₄, LiNi_{0.5}Mn_{1.5}O₄, and Li₄Ti₅O₁₂. From the viewpoint of reactivity during co-sintering with the LISICON-type solid electrolyte used in the present invention, a lithium-containing layered oxide such as LiCoO₂ or LiCo_{1/3}Ni_{1/3}Mn_{1/3}O₂ is more preferably used as the positive electrode active material. Note that only one type of these positive electrode active material particles may be used, or a plurality of types may be mixed and used.

The positive electrode active material having a NASICON-type structure in the positive electrode layer means that the positive electrode active material (in particular, its particles have a NASICON-type crystal structure, and in a broad sense, it means that the positive electrode active material has a crystal structure that may be recognized as a NASICON-type crystal structure by a person skilled in the art of solid-state batteries. In a narrow sense, the fact that the positive electrode active material has a NASICON-type structure in the positive electrode layer means that the positive electrode active material (in particular, particles thereof) exhibits, at a predetermined incident angle, one or more main peaks corresponding to a Miller index that is unique to a so-called NASICON-type crystal structure in X-ray diffraction. Examples of a preferably used positive electrode active material having the NASICON-type structure include the compounds exemplified above.

The positive electrode active material having the olivine-type structure in the positive electrode layer means that the positive electrode active material (particularly, particles thereof) has an olivine-type crystal structure, and means in a broad sense that the positive electrode active material has a crystal structure that can be recognized as an olivine-type crystal structure by a person skilled in the art of solid-state batteries. In a narrow sense, the fact that the positive electrode active material has an olivine-type structure in the positive electrode layer means that the positive electrode active material (in particular, particles thereof) exhibits, at a predetermined incident angle, one or more main peaks corresponding to a Miller index that is unique to a so-called olivine-type crystal structure in X-ray diffraction. Examples of a preferably used positive electrode active material having the olivine-type structure include the compounds exemplified above.

The positive electrode active material having the spinel-type structure in the positive electrode layer means that the positive electrode active material (particularly, particles thereof) has a spinel-type crystal structure, and means in a broad sense that the positive electrode active material has a crystal structure that can be recognized as a spinel-type crystal structure by those skilled in the art of solid-state batteries. In a narrow sense, the positive electrode active material having a spinel-type structure in the positive electrode layer means that the positive electrode active material (in particular, its particles) exhibits one or more main peaks corresponding to Miller indices unique to a so-called spinel-type crystal structure at a predetermined incident angle in X-ray diffraction. Examples of a preferably used positive electrode active material having the spinel-type structure include the compounds exemplified above.

The chemical composition of the positive electrode active material may be an average chemical composition. The average chemical composition of the positive electrode active material means an average value of the chemical compositions of the positive electrode active material in the thickness direction of the positive electrode layer. The average chemical composition of the positive electrode active material can be analyzed and measured by breaking the solid-state battery and performing composition analysis by energy-dispersive X-ray spectroscopy (EDX) using SEM-EDX in a field of view in which the entire positive electrode layer fits in the thickness direction.

The positive electrode active material may be produced, for example, by the following method, or may be obtained as a commercially available product. In producing a positive electrode active material, first, a raw material compound containing a predetermined metal atom is weighed to have a predetermined chemical composition, and water is added and mixed to obtain a slurry. Next, the slurry is dried, calcined at 700° C. or higher and 1000° C. or lower for 1 hour or longer and 30 hours or shorter, and pulverized, whereby a positive electrode active material may be obtained.

The chemical composition and crystal structure of the positive electrode active material in the positive electrode layer may be usually changed by element diffusion during sintering. The positive electrode active material may have the chemical composition and crystal structure described above in the solid-state battery after being sintered together with the negative electrode layer and the solid electrolyte layer.

The average particle size of the positive electrode active material is not particularly limited but may be, for example, 0.01 μm to 10 μm, and preferably 0.05 μm to 4 μm.

As the average particle size of the positive electrode active material, for example, 10 to 100 particles are randomly selected from the SEM image, and the particle sizes thereof may be simply averaged to determine the average particle size (arithmetic average).

The particle size is the diameter of a spherical particle when the particle is assumed to be a perfect sphere. For such a particle size, for example, a section of the solid-state battery is cut out, a sectional SEM image is photographed using an SEM, the sectional area S of the particle is calculated using image analysis software (for example, “Azo-kun” (manufactured by Asahi Kasei Engineering Corporation)), and then the particle diameter R may be determined by the following formula:

R=2×(S/π)^{1/2}

The average particle size of the positive electrode active material in the positive electrode layer may be automatically measured by specifying the positive electrode active material according to the composition at the time of measuring the average chemical composition described above.

Usually, the average particle size of the positive electrode active material in the positive electrode layer may change due to sintering in the process of producing the solid-state battery. In the solid-state battery after being sintered together with the negative electrode layer and the solid electrolyte layer, the positive electrode active material may have the average particle size described above.

The proportion by volume of the positive electrode active material in the positive electrode layer is not particularly limited, and may be, for example, 30% to 90%, and particularly 40% to 70%.

The positive electrode layer may contain the solid electrolyte ceramic of the present invention as a solid electrolyte, and/or may contain a solid electrolyte other than the solid electrolyte ceramic of the present invention.

The positive electrode layer may further contain a sintering aid and/or a conductive material.

When the positive electrode layer contains the solid electrolyte ceramic of the present invention, the proportion by volume of the solid electrolyte ceramic of the present invention may be usually 20% to 60%, and particularly 30% to 45%.

As the sintering aid in the positive electrode layer, the same compound as the sintering aid that may be contained in the solid electrolyte ceramic may be used.

The proportion by volume of the sintering aid in the positive electrode layer is not particularly limited, and for example, is preferably 0.1% to 20% and more preferably 1% to 10%.

As the conductive material in the positive electrode layer, a conductive material known in the field of solid-state batteries may be used. Examples of the conductive material to be preferably used include metal materials such as silver (Ag), gold (Au), palladium (Pd), platinum (Pt), copper (Cu), tin (Sn), and nickel (Ni); and carbon materials such as carbon nanotubes, for example, acetylene black, Ketjen black, Super P (registered trademark), and VGCF (registered trademark). The shape of the carbon material is not particularly limited, and any shape such as a spherical shape, a plate shape, and a fibrous shape may be used.

The proportion by volume of the conductive material in the positive electrode layer is not particularly limited, and for example, is preferably 10% to 50% and more preferably 20% to 40%.

The thickness of the positive electrode layer is usually 0.1 to 30 μm, and for example, preferably 1 to 20 μm. As the thickness of the positive electrode layer, an average value of thicknesses measured at any 10 points in an SEM image is used.

In the positive electrode layer, the porosity is not particularly limited, but is preferably 20% or less, more preferably 15% or less, and still more preferably 10% or less.

As the porosity of the positive electrode layer, a value measured from an SEM image after FIB section processing is used.

The positive electrode layer is a layer that may be referred to as a “positive electrode active material layer”. The positive electrode layer may have a so-called positive electrode current collector or a positive electrode current collecting layer.

(Negative Electrode Layer)

In the solid-state battery of the present invention, the negative electrode layer is not particularly limited. For example, the negative electrode layer contains a negative electrode active material and may further contain the solid electrolyte ceramic of the present invention. When the solid electrolyte ceramic of the present invention is contained in the negative electrode layer, a short circuit of the solid-state battery can be suppressed. The negative electrode layer may have a form of a sintered body containing negative electrode active material particles. The negative electrode layer may be a layer capable of occluding and releasing ions (in particular, lithium ions).

The negative electrode active material is not particularly limited, and a negative electrode active material known in the field of solid-state batteries may be used. Examples of the negative electrode active material include carbon materials such as graphite, graphite-lithium compounds, lithium metal, lithium alloy particles, phosphate compounds having a NASICON-type structure, Li-containing oxides having a spinel-type structure, and oxides having a β_{II}-Li₃VO₄-type structure and a γ_{II}-Li₃VO₄-type structure. As the negative electrode active material, it is preferable to use lithium metal or a Li-containing oxide having a β_{II}-Li₃VO₄-type structure or a γ_{II}-Li₃VO₄-type structure.

The oxide having a β_{II}-Li₃VO₄-type structure in the negative electrode layer means that the oxide (in particular, its particles) has a β_{II}-Li₃VO₄-type crystal structure, and in a broad sense, it means that the oxide has a crystal structure that may be recognized as a β_{II}-Li₃VO₄-type crystal structure by a person skilled in the art of solid-state batteries. In a narrow sense, the oxide having a β_{II}-Li₃VO₄-type structure in the negative electrode layer means that the oxide (in particular, its particles) exhibits one or more main peaks corresponding to Miller indices unique to a so-called β_{II}-Li₃VO₄-type crystal structure at a predetermined incident angle in X-ray diffraction. Examples of the Li-containing oxide having a β_{II}-Li₃VO₄-type structure preferably used include Li₃VO₄.

The oxide having a γ_{II}-Li₃VO₄-type structure in the negative electrode layer means that the oxide (in particular, its particles) has a γ_{II}-Li₃VO₄-type crystal structure, and in a broad sense, it means that the oxide has a crystal structure that may be recognized as a γ_{II}-Li₃VO₄-type crystal structure by a person skilled in the art of solid-state batteries. In a narrow sense, the oxide having a γ_{II}-Li₃VO₄-type structure in the negative electrode layer means that the oxide (in particular, its particles) exhibits one or more main peaks corresponding to Miller indices unique to a so-called γ_{II}-Li₃VO₄-type crystal structure at a predetermined incident angle (x-axis) in X-ray diffraction. Examples of the Li-containing oxide having a γ_{II}-Li₃VO₄-type structure preferably used include Li_{3.2}V_{0.8}Si_{0.2}O₄.

The chemical composition of the negative electrode active material may be an average chemical composition. The average chemical composition of the negative electrode active material means an average value of the chemical compositions of the negative electrode active material in the thickness direction of the negative electrode layer. The average chemical composition of the negative electrode active material may be analyzed and measured by breaking the solid-state battery and performing composition analysis by EDX using SEM-EDX (energy dispersive X-ray spectroscopy) in a field of view in which the whole negative electrode layer fits in the thickness direction.

The negative electrode active material may be produced, for example, by the same method as the positive electrode active material or may be obtained as a commercially available product.

Usually, the chemical composition and crystal structure of the negative electrode active material in the negative electrode layer may be changed by element diffusion during sintering in the production process of the solid-state battery. The negative electrode active material may have the average chemical composition and crystal structure described above in the solid-state battery after being sintered together with the positive electrode layer and the solid electrolyte layer.

The proportion by volume of the negative electrode active material in the negative electrode layer is not particularly limited, and for example, is preferably 50% or more (particularly 50% to 99%), more preferably 70% to 95%, and still more preferably 80% to 90%.

The negative electrode layer may contain the solid electrolyte ceramic of the present invention as a solid electrolyte, and/or may contain a solid electrolyte other than the solid electrolyte ceramic of the present invention.

The negative electrode layer may further contain a sintering aid and/or a conductive material.

When the negative electrode layer contains the solid electrolyte ceramic of the present invention, the proportion by volume of the solid electrolyte ceramic of the present invention may be usually 20% to 60%, and particularly 30% to 45%.

As the sintering aid in the negative electrode layer, the same compound as the sintering aid in the positive electrode layer may be used.

As the conductive material in the negative electrode layer, the same compound as the conductive material in the positive electrode layer may be used.

The thickness of the negative electrode layer is usually 0.1 to 30 μm and preferably 1 to 20 μm. As the thickness of the negative electrode layer, an average value of thicknesses measured at any 10 points in an SEM image is used.

In the negative electrode layer, the porosity is not particularly limited, but is preferably 20% or less, more preferably 15% or less, and still more preferably 10% or less.

As the porosity of the negative electrode layer, a value measured by the same method as the porosity of the positive electrode layer is used.

The negative electrode layer is a layer that may be referred to as a “negative electrode active material layer”. The negative electrode layer may have a so-called negative electrode current collector or a negative electrode current collecting layer.

(Solid Electrolyte Layer)

In the solid-state battery of the present invention, the solid electrolyte layer preferably contains the solid electrolyte ceramic of the present invention described above from the viewpoint of more excellent ion conductivity and more sufficient suppression of an increase in electron conductivity during operation.

The proportion by volume of the solid electrolyte ceramic of the present invention in the solid electrolyte layer is not particularly limited, and is preferably 10% to 100%, more preferably 20% to 100%, and still more preferably 30% to 100%, from the viewpoint of more excellent ion conductivity and more sufficient suppression of an increase in electron conductivity during operation.

When the solid electrolyte layer contains the solid electrolyte ceramic of the present invention, the solid electrolyte ceramic of the present invention having the chemical composition may be present at least at the central part (particularly, 5 points or more, preferably 8 points or more, and more preferably 10 points in the arbitrary 10 points) in the thickness direction of the solid electrolyte layer. This is because the solid electrolyte layer is sandwiched between the positive electrode layer and the negative electrode layer, and element diffusion from the positive electrode layer and the negative electrode layer to the solid electrolyte layer and/or element diffusion from the solid electrolyte layer to the positive electrode layer and the negative electrode layer may occur by sintering in the manufacturing process of a solid-state battery.

In addition to the garnet-type solid electrolyte ceramic of the present invention, the solid electrolyte layer may contain one or more materials selected from a solid electrolyte composed of at least Li, Zr, and O, a solid electrolyte having a γ-Li₃VO₄ structure, and an oxide glass ceramic-based lithium ion conductor. Examples of the solid electrolyte composed of at least Li, Zr, and O include Li₂ZrO₃.

Examples of the solid electrolyte having a γ-Li₃VO₄ structure include a solid electrolyte having an average chemical composition represented by the following Formula (III).

Li_{[3-ax+(5-c)(1-y)]}Aₓ)(B_{y}D_{1-y})O₄ (III)

In Formula (III), A is one or more elements selected from the group consisting of Na, K, Mg, Ca, Al, Ga, Zn, Fe, Cr, and Co.

B is one or more elements selected from the group consisting of V and P.

D is one or more elements selected from the group consisting of Zn, Al, Ga, Si, Ge, Sn, As, Ti, Mo, W, Fe, Cr, and Co.

x satisfies 0≤x≤1.0, particularly satisfies 0≤x≤0.2.

y satisfies 0≤y≤1.0, particularly satisfies 0.20≤y≤0.50.

a is an average valence of A. The average valence of A is, for example, a value represented by (n1×a+n2×b+n3×c)/(n1+n2+n3) when A is recognized as n1 of elements X having a valence a+, n2 of elements Y having a valence b+, and n3 of elements Z having a valence c+.

c is an average valence of D. The average valence of D is, for example, the same value as the average valence of A described above when D is recognized as n1 of elements X having a valence a+, n2 of elements Y having a valence b+, and n3 of elements Z having a valence c+.

Specific examples of the solid electrolyte having a γ-Li₃VO₄ structure include Li_{3.2}(V_{0.8}Si_{0.2})O₄, Li_{3.5}(V_{0.5}Ge_{0.5})O₄, Li_{3.4}(P_{0.6}Si0.4)O₄, and Li_{3.5}(P_{0.5}Ge_{0.5})O₄.

As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

The solid electrolyte layer may further contain, for example, a sintering aid and the like in addition to the solid electrolyte.

As the sintering aid in the solid electrolyte layer, the same compound as the sintering aid in the positive electrode layer may be used.

The proportion by volume of the sintering aid in the solid electrolyte layer is not particularly limited, and is preferably 0% to 20%, and more preferably 1% to 10%, from the viewpoint of more excellent ion conductivity and more sufficient suppression of an increase in electron conductivity during operation.

The thickness of the solid electrolyte layer is usually 0.1 to 30 μm and is preferably 1 to 20 μm from the viewpoint of more excellent ion conductivity and more sufficient suppression of an increase in electron conductivity during operation. As the thickness of the solid electrolyte layer, an average value of thicknesses measured at any 10 points in an SEM image is used.

In the solid electrolyte layer, the porosity is not particularly limited, and is preferably 20% or less, more preferably 15% or less, and still more preferably 10% or less, from the viewpoint of more excellent ion conductivity and more sufficient suppression of an increase in electron conductivity during operation.

As the porosity of the solid electrolyte layer, a value measured by the same method as the porosity of the positive electrode layer is used.

[Method for Manufacturing Solid-State Battery]

The solid-state battery can be manufactured, for example, by a so-called green sheet method, a printing method, or a combined method thereof.

The green sheet method will be described.

First, a solvent, a binder, and the like are appropriately mixed with a positive electrode active material to prepare a paste. The paste is applied onto a sheet and dried to form a first green sheet for forming a positive electrode layer. The first green sheet may contain a solid electrolyte, a conductive material, and/or a sintering aid.

A solvent, a binder, and the like are appropriately mixed with a negative electrode active material to prepare a paste. The paste is applied onto a sheet, and dried to form a second green sheet for constituting the negative electrode layer. The second green sheet may contain a solid electrolyte, a conductive material, and/or a sintering aid.

A solvent, a binder, and the like are appropriately mixed with a solid electrolyte to prepare a paste. The paste is applied onto a sheet and dried to form a third green sheet for forming a solid electrolyte layer. The third green sheet may contain a sintering aid and the like.

The solvent for producing the first to third green sheets is not particularly limited, and for example, a solvent that may be used for producing a positive electrode layer, a negative electrode layer, or a solid electrolyte layer in the field of solid-state batteries is used. As the solvent, a solvent capable of using the binder described later is usually used. Examples of such a solvent include alcohols such as 2-propanol.

The binder for producing the first to third green sheets is not particularly limited, and for example, a binder that may be used for producing a positive electrode layer, a negative electrode layer, or a solid electrolyte layer in the field of solid-state batteries is used. Examples of such a binder include a butyral resin and an acrylic resin.

Next, the first to third green sheets are appropriately stacked to produce a laminate. The produced laminate may be pressed. Examples of a preferable pressing method include an isostatic pressing method.

Thereafter, the laminate is heat-treated at, for example, 600 to 800° C. to obtain a solid-state battery.

The printing method will be described.

The printing method is the same as the green sheet method except for the following matters.

An ink of each layer is prepared, the ink having the same composition as the composition of the paste of each layer for obtaining a green sheet except that the blending amounts of the solvent and the resin are adjusted to those suitable for use as the ink.

The ink of each layer is printed and stacked to produce a laminate.

Hereinafter, the present invention will be described in more detail based on specific examples, but the present invention is not limited to the following examples at all and may be appropriately changed and implemented without changing the gist thereof.

### Examples

### Examples 1 to 26 and Comparative Examples 1 to 8

[Production of Solid Electrolyte Ceramic]

Lithium hydroxide monohydrate LiOH—H₂O, lanthanum hydroxide La(OH)₃, zirconium oxide ZrO₂, tantalum oxide Ta₂O₅, bismuth oxide Bi₂O₃, cobalt oxide CO₃O₄, basic nickel carbonate hydrate NiCO₃·2Ni(OH)₂·4H₂O, manganese carbonate MnCO₃, and iron oxide Fe₂O₃ were used for raw materials.

Each starting material was weighed so as to have each chemical composition in Table 1.

Water was added, the resulting mixture was sealed in a polyethylene polypot, and the polypot was rotated on a pot rack at 150 rpm for 16 hours to mix the raw materials.

Lithium hydroxide monohydrate LiOH—H₂O as a Li source was charged in an excess of 3 wt % with respect to the target composition in consideration of Li deficiency during the heat treatment.

The obtained slurry was evaporated and dried, and then calcined in O₂ at 900° C. for 5 hours to obtain a target phase.

The calcined powder obtained was, with the addition of a mixed solvent of toluene-acetone thereto, subjected to grinding for 12 hours in a planetary ball mill. This ground powder was confirmed to have no compositional deviation through ICP measurement. The average particle size of the ground powder at this time was 150 nm.

[Production of Solid Electrolyte Single Plate]

As a sample for evaluation of a solid electrolyte ceramic, a solid electrolyte single plate was produced by the following method.

The obtained solid electrolyte powder, a butyral resin, and an alcohol were mixed thoroughly in proportions by mass of 200:15:140, and alcohol was then removed on a hot plate at 80° C., thereby providing a powder coated with the butyral resin to serve as a binder.

Next, the coated powder was pressed at 90 MPa and molded into a tablet shape with the use of a tablet molding machine.

The tablet was sufficiently coated with a mother powder, degreased under an oxygen atmosphere at a temperature of 500° C. to remove the butyral resin, and then heat-treated under an oxygen atmosphere at about 1200° C. for 3 hours, and the temperature was decreased to room temperature, thereby obtaining a sintered body of a solid electrolyte.

A surface of the resultant sintered body was polished to obtain a garnet solid electrolyte single plate.

[Crystal Structure of Solid Electrolyte Single Plate]

In all Examples and Comparative Examples, it was confirmed that X-ray diffraction images capable of being assigned to a pseudo-garnet-type crystal structure were obtained from X-ray diffraction of the solid electrolyte single plate (ICDD Card No. 00-045-0109).

[Chemical Composition of Solid Electrolyte Single Plate]

The solid electrolyte single plate was subjected to ICP analysis to obtain the average chemical composition of the solid electrolyte single plate. The contents of Co, Mn, Ni, and Fe in the average chemical composition of the whole solid electrolyte single plate were determined as a ratio when the number of eight-coordination sites in the garnet-type crystal structure (for example, the total number of La and B¹ in Formula (II) described above) was 100 mol %. Oxygen (O) in the chemical composition is a value calculated so as to establish charge neutrality from the molar ratio and valence of the elements included in A, B, and D in Formula (I).

[Electron Conductivity Measurement]

An Au electrode was sputtered on one surface of the obtained single plate to obtain a working electrode. A Li metal having the same area as the Au electrode was attached to the other surface. Finally, a cell was enclosed in a 2035 size coin cell to obtain an evaluation cell. All the operations described above were performed in a dry room having a dew point of −40° C. or lower.

At room temperature, 2 V relative to Li was applied to the working electrode, and a transient current was observed. The current that flowed 10 hours after the voltage application was read as the leakage current. From the leakage current, the electron conductivity was calculated using the following formula:

Electron conductivity=(I/V)×(L/A)

(I: leakage current, V: applied voltage, L: solid electrolyte single plate thickness, A: electrode area)

⊙: electron conductivity<1.0×10⁻⁸ S/cm (excellent);

∘; 1.0×10⁻⁸ S/cm electron conductivity<5.0×10⁻⁸ S/cm (good);

Δ; 5.0×10⁻⁸ S/cm electron conductivity<1.0×10⁻⁷ S/cm (acceptable) (has no practical problem);

x; 1.0×10⁻⁷ S/cm electron conductivity (not acceptable) (has a practical problem).

[Measurement of Ionic Conductivity]

A gold (Au) layer serving as a current collector layer was formed on both surfaces of a solid electrolyte single plate by sputtering, and then the resulting gold layer was sandwiched by SUS current collectors and fixed. The sintered tablet of each solid electrolyte was subjected to AC impedance measurement at room temperature (25° C.) in the range of 10 MHz to 0.1 Hz (±50 mV) to evaluate the ionic conductivity.

⊙: 1.3×10⁻³ S/cm ionic conductivity (excellent);

∘; 1.0×10⁻³ S/cm ionic conductivity<1.3×10⁻³ S/cm (good);

Δ; 4.0×10⁻⁴ S/cm ionic conductivity<1.0×10⁻³ S/cm (acceptable) (has no practical problem);

x; ionic conductivity<4.0×10⁻⁴ S/cm (not acceptable) (has a practical problem).

[Comprehensive Determination]

All the evaluation results of the electron conductivity and the ionic conductivity were comprehensively determined.

⊙: All the evaluation results of the electron conductivity and the ionic conductivity were “⊙”.

∘: The lowest evaluation result among all the evaluation results of the electron conductivity and the ionic conductivity was “∘”.

Δ; The lowest evaluation result among all the evaluation results of the electron conductivity and the ionic conductivity was “Δ”.

x; The lowest evaluation result among all the evaluation results of the electron conductivity and the ionic conductivity was “x”

TABLE 1

| | | | Co | Bi |
|---|---|---|---|---|
| | | Ta | Content Y | Content |
| | | Content X | Molar ratio | Molar ratio |
| | Chemical composition | Molar ratio | (%) | (%) |
| | (A_{α}B_{β}D_{γ}O_{ω}) (I) | (mol %)* | (mol %)* | (mol %)* |
| Comparative | Li6.4La3Zr1.4Ta0.3Bi0.3O12-Co0.05 | 10.00 | 1.67 | 10 |
| Example 1 | | | | |
| Comparative | Li6.4La3Zr1.4Ta0.3Bi0.3O12-Co0.1 | 10.00 | 3.33 | 10 |
| Example 2 | | | | |
| Example 1 | Li6.3La3Zr1.28Ta0.42Bi0.3O12-Co0.05 | 14.00 | 1.67 | 10 |
| Example 2 | Li6.3La3Zr1.28Ta0.42Bi0.3O12-Co0.1 | 14.00 | 3.33 | 10 |
| Example 3 | Li6.2La3Zr1.2Ta0.5Bi0.3O12-Co0.05 | 16.67 | 1.67 | 10 |
| Example 4 | Li6.2La3Zr1.2Ta0.5Bi0.3O12-Co0.1 | 16.67 | 3.33 | 10 |
| Comparative | Li6.2La3Zr1.2Ta0.5Bi0.3O12-Co0.15 | 16.67 | 5.00 | 10 |
| Example 3 | | | | |
| Example 5 | Li6.1La3Zr1.1Ta0.6Bi0.3O12-Co0.05 | 20.00 | 1.67 | 10 |
| Example 6 | Li6.1La3Zr1.1Ta0.6Bi0.3O12-Co0.1 | 20.00 | 3.33 | 10 |
| Example 7 | Li6.1La3Zr1.1Ta0.6Bi0.3O12-Co0.15 | 20.00 | 5.00 | 10 |
| Example 8 | Li5.9La3Zr0.9Ta0.8Bi0.3O12-Co0.05 | 26.67 | 1.67 | 10 |
| Example 9 | Li5.9La3Zr0.9Ta0.8Bi0.3O12-Co0.1 | 26.67 | 3.33 | 10 |
| Example 10 | Li5.9La3Zr0.9Ta0.8Bi0.3O12-Co0.15 | 26.67 | 5.00 | 10 |
| Comparative | Li6.1La3Zr1.1Ta0.6Bi0.3O12-Co0.2 | 20.00 | 6.67 | 10 |
| Example 4 | | | | |
| Comparative | Li5.9La3Zr0.9Ta0.8Bi0.3O12-Co0.2 | 26.67 | 6.67 | 10 |
| Example 5 | | | | |
| Example 11 | Li5.7La3Zr0.7Ta1Bi0.3O12-Co0.05 | 33.33 | 1.67 | 10 |
| Example 12 | Li5.7La3Zr0.7Ta1Bi0.3O12-Co0.1 | 33.33 | 3.33 | 10 |
| Example 13 | Li5.7La3Zr0.7Ta1Bi0.3O12-Co0.15 | 33.33 | 5.00 | 10 |
| Example 14 | Li5.7La3Zr0.7Ta1Bi0.3O12-Co0.2 | 33.33 | 6.67 | 10 |
| Example 15 | Li5.2La3Zr0.2Ta1.5Bi0.3O12-Co0.05 | 50.00 | 1.67 | 10 |
| Example 16 | Li5.2La3Zr0.2Ta1.5Bi0.3O12-Co0.1 | 50.00 | 3.33 | 10 |
| Example 17 | Li5.2La3Zr0.2Ta1.5Bi0.3O12-Co0.15 | 50.00 | 5.00 | 10 |
| Example 18 | Li5.2La3Zr0.2Ta1.5Bi0.3O12-Co0.2 | 50.00 | 6.67 | 10 |
| Example 19 | Li5La3Ta1.95Bi0.05O12-Co0.05 | 65.00 | 1.67 | 10 |
| Example 20 | Li5La3Ta1.95Bi0.05O12-Co0.1 | 65.00 | 3.33 | 1.67 |
| Example 21 | Li5La3Ta1.95Bi0.05O12-Co0.15 | 65.00 | 5.00 | 1.67 |
| Example 22 | Li5La3Ta1.95Bi0.05O12-Co0.2 | 65.00 | 6.67 | 1.67 |
| Comparative | Li5.7La3Zr0.7Ta1Bi0.3O12-Co0.25 | 33.33 | 8.33 | 1.67 |
| Example 6 | | | | |
| Comparative | Li5.2La3Zr0.2Ta1.5Bi0.3O12-Co0.25 | 50.00 | 8.33 | 10 |
| Example 7 | | | | |
| Comparative | Li5La3Ta1.95Bi0.05O12-Co0.25 | 65.00 | 8.33 | 1.67 |
| Example 8 | | | | |

| | | | Electron | | Compre- |
|---|---|---|---|---|---|
| | Ionic | | conduc- | | hensive |
| | conductivity | Deter- | tivity | Deter- | deter- |
| | (S/cm) | mination | ( S/cm) | mination | mination |
| Comparative | 7.7 × 10⁻⁵ | X | 1.1 × 10⁻⁶ | X | X |
| Example 1 | | | | | |
| Comparative | 5.7 × 10⁻⁵ | X | 1.3 × 10⁻⁶ | X | X |
| Example 2 | | | | | |
| Example 1 | 1.3 × 10⁻³ | ⊙ | 6.7 × 10⁻⁹ | ⊙ | ⊙ |
| Example 2 | 1.3 × 10⁻³ | ⊙ | 6.1 × 10⁻⁹ | ⊙ | ⊙ |
| Example 3 | 1.3 × 10⁻³ | ⊙ | 7.0 × 10⁻⁹ | ⊙ | ⊙ |
| Example 4 | 1.3 × 10⁻³ | ⊙ | 6.3 × 10⁻⁹ | ⊙ | ⊙ |
| Comparative | 1.2 × 10⁻³ | ◯ | 8.2 × 10⁻⁷ | X | X |
| Example 3 | | | | | |
| Example 5 | 1.1 × 10⁻³ | ◯ | 7.1 × 10⁻⁹ | ⊙ | ◯ |
| Example 6 | 1.1 × 10⁻³ | ◯ | 6.7 × 10⁻⁹ | ⊙ | ◯ |
| Example 7 | 1.1 × 10⁻³ | ◯ | 6.4 × 10⁻⁹ | ⊙ | ◯ |
| Example 8 | 1.1 × 10⁻³ | ◯ | 7.1 × 10⁻⁹ | ⊙ | ◯ |
| Example 9 | 1.1 × 10⁻³ | ◯ | 6.6 × 10⁻⁹ | ⊙ | ◯ |
| Example 10 | 1.0 × 10⁻³ | ◯ | 5.7 × 10⁻⁹ | ⊙ | ◯ |
| Comparative | 10 | ◯ | 1.2 × 10⁻⁶ | X | X |
| Example 4 | | | | | |
| Comparative | 10 | ◯ | 1.4 × 10⁻⁶ | X | X |
| Example 5 | | | | | |
| Example 11 | 9.9 × 10⁻⁴ | Δ | 7.2 × 10⁻⁹ | ⊙ | Δ |
| Example 12 | 8.8 × 10⁻⁴ | Δ | 5.7 × 10⁻⁹ | ⊙ | Δ |
| Example 13 | 8.4 × 10⁻⁴ | Δ | 3.9 × 10⁻⁹ | ⊙ | Δ |
| Example 14 | 7.2 × 10⁻⁴ | Δ | 2.2 × 10⁻⁹ | ⊙ | Δ |
| Example 15 | 5.1 × 10⁻⁴ | Δ | 7.2 × 10⁻⁹ | ⊙ | Δ |
| Example 16 | 5.0 × 10⁻⁴ | Δ | 7.0 × 10⁻⁹ | ⊙ | Δ |
| Example 17 | 4.9 × 10⁻⁴ | Δ | 5.1 × 10⁻⁹ | ⊙ | Δ |
| Example 18 | 4.4 × 10⁻⁴ | Δ | 4.0 × 10⁻⁹ | ⊙ | Δ |
| Example 19 | 4.3 × 10⁻⁴ | Δ | 7.2 × 10⁻⁹ | ⊙ | Δ |
| Example 20 | 4.2 × 10⁻⁴ | Δ | 5.3 × 10⁻⁹ | ⊙ | Δ |
| Example 21 | 4.1 × 10⁻⁴ | Δ | 3.7 × 10⁻⁹ | ⊙ | Δ |
| Example 22 | 4.1 × 10⁻⁴ | Δ | 2.5 × 10⁻⁹ | ⊙ | Δ |
| Comparative | 6.8 × 10⁻⁴ | Δ | 1.1 × 10⁻⁶ | X | X |
| Example 6 | | | | | |
| Comparative | 4.4 × 10⁻⁴ | Δ | 8.1 × 10⁻⁷ | X | X |
| Example 7 | | | | | |
| Comparative | 4.1 × 10⁻⁴ | Δ | 1.3 × 10⁻⁶ | X | X |
| Example 8 | | | | | |

*It is a content when the content of B is 100 mol %.

TABLE 2

| | | | Co/Mn/Ni | Bi |
|---|---|---|---|---|
| | | Ta | Content Y | Content |
| | | Content X | Molar ratio | Molar ratio |
| | Chemical composition | Molar ratio | (%) | (%) |
| | (A_{α}B_{β}D_{γ}O_{ω}) (I) | (mol %)* | (mol %)* | (mol %)* |
| Example 23 | Li6.3La3Zr1.28Ta0.42Bi0.3O12-Co0.001 | 14.00 | 0.03 | 10 |
| Example 24 | Li5La3Ta1.95Bi0.05O12-Co0.001 | 65.00 | 0.03 | 1.67 |
| Example 25 | Li6.3La3Zr1.28Ta0.42Bi0.3O12-Mn0.001 | 14.00 | 0.03 | 10 |
| Example 26 | Li6.3La3Zr1.28Ta0.42Bi0.3O12-Ni0.001 | 14.00 | 0.03 | 10 |

| | | | Electron | | Compre- |
|---|---|---|---|---|---|
| | Ionic | | conduc- | | hensive |
| | conductivity | Deter- | tivity | Deter- | deter- |
| | (S/cm) | mination | ( S/cm) | mination | mination |
| Example 23 | 1.3 × 10⁻³ | ⊙ | 6.5 × 10⁻⁹ | ⊙ | ⊙ |
| Example 24 | 4.4 × 10⁻⁴ | Δ | 7.0 × 10⁻⁹ | ⊙ | Δ |
| Example 25 | 1.3 × 10⁻³ | ⊙ | 4.5 × 10⁻⁸ | ◯ | ◯ |
| Example 26 | 1.3 × 10⁻³ | ⊙ | 8.0 × 10⁻⁸ | Δ | Δ |

*It is a content when the content of B is 100 mol %.

From comparison between Comparative Examples 1 and 2 and Examples 1 to 4, it is apparent that the ionic conductivity decreases when the content of the second transition metal element (particularly, Ta) is less than 12.0 mol %.

From comparison between Examples 1 to 4 and Comparative Example 3, it is apparent that when the content of the second transition metal element (particularly, Ta) is a range of 12 mol % to less than 20.0 mol % and the content of the first transition metal element (particularly, Co) is more than 4.00 mol %, the electron conductivity is enhanced, and the risk of a short circuit is increased.

From comparison between Examples 5 to 10 and Comparative Examples 4 and 5, it is apparent that when the content of the second transition metal element (particularly, Ta) is a range of 20.0 mol % to less than 33.0 mol % and the content of the first transition metal element (particularly, Co) is more than 6.00 mol %, the electron conductivity is enhanced, and the risk of a short circuit is increased.

From comparison between Examples 11 to 22 and Comparative Examples 6 to 8, it is apparent that when the content of the second transition metal element (particularly, Ta) is a range of 33.0 mol % to 65.5 mol % and the content of the first transition metal element (particularly, Co) is more than 8.00 mol %, the electron conductivity is enhanced, and the risk of a short circuit is increased.

The solid-state battery including the solid electrolyte ceramic of the present invention can be used in various fields where battery use or power storage is assumed. Although it is merely an example, the solid-state battery according to an embodiment of the present invention can be used in the field of electronics mounting. The solid-state battery according to an embodiment of the present invention can also be used in the fields of electricity, information, and communication in which mobile devices and the like are used (for example, electric and electronic equipment fields or mobile equipment fields including mobile phones, smartphones, smartwatches, notebook computers, and small electronic machines such as digital cameras, activity meters, arm computers, electronic papers, wearable devices, RFID tags, card-type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as hearing aid buds), pharmaceutical applications (fields such as dosage management systems), IoT fields, space and deep sea applications (for example, fields such as space probes and submersibles), and the like.

1. A solid electrolyte ceramic having a garnet-type crystal structure, the solid electrolyte ceramic comprising:
at least Li, La, and O; and
one or more transition metal elements selected from the group consisting of Co, Ni, Mn, and Fe,
the solid electrolyte ceramic having a chemical composition represented by:
A_{α}B_{β}D_{γ}O_{ω} (I)
wherein A is one or more elements selected from the group consisting of the Li, Ga, Al, Mg, Zn, and Sc, and includes at least the Li,
B is one or more elements selected from the group consisting of the La, Ca, Sr, Ba, and lanthanoid elements, and includes at least the La,
D is one or more elements selected from the group consisting of a transition element capable of providing six-coordination with oxygen and an element belonging to Groups 12 to 15,
5.0≤α≤8.0;
2.5≤β≤3.5;
1.5≤γ≤2.5;
11≤ω≤13,
wherein, when a content of the B is 100 mol %, a content of the D is designated as X (mol %), and a total content of the transition metal elements is designated as Y (mol %), the solid electrolyte ceramic satisfies any one of relational expressions (1) to (3):
0.01≤Y≤4.00 in a range of 12.0≤X<20.0; (1)
0.01≤Y≤6.00 in a range of 20.0≤X<33.0; (2)
0.01≤Y≤8.00 in a range of 33.0≤X≤65.5. (3)

2. The solid electrolyte ceramic according to claim 1, wherein:
5.0≤α≤7.0,
2.5≤β≤3.3,
1.8≤γ≤2.5,
11≤ω≤12.5.

3. The solid electrolyte ceramic according to claim 1, wherein the solid electrolyte ceramic further comprises Bi.

4. The solid electrolyte ceramic according to claim 3, wherein, when the content of the D is 100 mol %, the content of the Bi is 25 mol % or less.

5. The solid electrolyte ceramic according to claim 1, wherein the one or more transition metal elements includes Co.

6. The solid electrolyte ceramic according to claim 1, wherein the D includes one or more additional transition metal elements selected from the group consisting of Ta and Nb.

7. The solid electrolyte ceramic according to claim 6, wherein the one or more additional transition metal elements includes Ta.

8. The solid electrolyte ceramic according to claim 1, wherein the solid electrolyte ceramic satisfies the relational expressions (1) or (2).

9. The solid electrolyte ceramic according to claim 1, wherein the solid electrolyte ceramic satisfies the relational expression (1).

10. The solid electrolyte ceramic according to claim 1, wherein the D includes Ta, and the content X of the D includes a content of the Ta.

11. The solid electrolyte ceramic according to claim 1, wherein the chemical composition of the solid electrolyte ceramic is at least one of:
Li_{6.3}La₃Zr_{1.28}Ta_{0.42}Bi_{0.3}O₁₂—Co_{0.05},
Li_{6.3}La₃Zr_{1.28}Ta_{0.42}Bi_{0.3}O₁₂—Co_{0.1},
Li_{6.2}La₃Zr_{1.2}Ta_{0.5}Bi_{0.3}O₁₂—Co_{0.05},
Li_{6.2}La₃Zr_{1.2}Ta_{0.5}Bi_{0.3}O₁₂—Co_{0.1},
Li_{6.1}La₃Zr_{1.1}Ta_{0.6}Bi_{0.3}O₁₂—Co_{0.05},
Li_{6.1}La₃Zr_{1.1}Ta_{0.6}Bi_{0.3}O₁₂—Co_{0.1},
Li_{6.1}La₃Zr_{1.1}Ta_{0.6}Bi_{0.3}O₁₂—Co_{0.15},
Li_{5.9}La₃Zr_{0.9}Ta_{0.8}Bi_{0.3}O₁₂—Co_{0.05},
Li_{5.9}La₃Zr_{0.9}Ta_{0.8}Bi_{0.3}O₁₂—Co_{0.1},
Li_{5.9}La₃Zr_{0.9}Ta_{0.8}Bi_{0.3}O₁₂—Co_{0.15},
Li_{5.7}La₃Zr_{0.7}Ta₁Bi_{0.3}O₁₂—Co_{0.05},
Li_{5.7}La₃Zr_{0.7}Ta₁Bi_{0.3}O₁₂—Co_{0.1},
Li_{5.7}La₃Zr_{0.7}Ta₁Bi_{0.3}O₁₂—Co_{0.15},
Li_{5.7}La₃Zr_{0.7}Ta₁Bi_{0.3}O₁₂—Co_{0.2},
Li_{5.2}La₃Zr_{0.2}Ta_{1.5}Bi_{0.3}O₁₂—Co_{0.05},
Li_{5.2}La₃Zr_{0.2}Ta_{1.5}Bi_{0.3}O₁₂—Co_{0.1},
Li_{5.2}La₃Zr_{0.2}Ta_{1.5}Bi_{0.3}O₁₂—Co_{0.15},
Li_{5.2}La₃Zr_{0.2}Ta_{1.5}Bi_{0.3}O₁₂—Co_{0.2},
Li₅La₃Ta_{1.95}Bi_{0.05}O₁₂—Co_{0.05},
Li₅La₃Ta_{1.95}Bi_{0.05}O₁₂—Co_{0.1},
Li₅La₃Ta_{1.95}Bi_{0.05}O₁₂—Co_{0.15}, and
Li₅La₃Ta_{1.95}Bi_{0.05}O₂—Co_{0.2}.

12. A solid-state battery comprising the solid electrolyte ceramic according to claim 1.

13. The solid-state battery according to claim 12, wherein the solid-state battery includes a positive electrode layer, a negative electrode layer, and a solid electrolyte layer stacked between the positive electrode layer and the negative electrode layer, and
the positive electrode layer and the negative electrode layer are layers capable of occluding and releasing lithium ions.

14. The solid-state battery according to claim 13, wherein the solid electrolyte layer and the positive electrode layer, and the solid electrolyte layer and the negative electrode layer are integrally sintered bodies.

15. The solid-state battery according to claim 12, wherein the solid electrolyte ceramic is contained in the solid electrolyte layer of the solid-state battery.
